(19) United States
(12) Patent Application Publication
(10) Pub. No.: US 2022/0322067 A1
(43) Pub. Date: Oct. 6, 2022

(54) METHOD AND APPARATUS FOR CONFIGURING TEMPORARY USER EQUIPMENT (UE) EXTERNAL IDENTIFIER IN WIRELESS COMMUNICATION SYSTEM

(71) Applicant: SAMSUNG ELECTRONICS CO., LTD., Suwon-si (KR)

(72) Inventors: Hyesung KIM, Suwon-si (KR); Jicheol LEE, Suwon-si (KR)

(21) Appl. No.: 17/658,215

(22) Filed: Apr. 6, 2022

(30) Foreign Application Priority Data
Apr. 6, 2021 (KR) 10-2021-0044532

(51) Int. Cl. H04W 8/18; H04W 12/06; H04W 12/0433

(52) U.S. Cl. CPC H04W 8/18; H04W 12/06; H04W 12/0433

(57) ABSTRACT

The disclosure relates to a 5G or 6G communication system for supporting a higher data transmission rate. According to the disclosure, it is possible for an external server located outside a mobile communication system to efficiently configure a temporary UE identifier for identifying a UE subscribing to the mobile communication system.

### CROSS-REFERENCE TO RELATED APPLICATION

This application is based on and claims priority under 35 U.S.C. § 119 to Korean Patent Application No. 10-2021-0044532, filed on Apr. 6, 2021, in the Korean Intellectual Property Office, the disclosure of which is herein incorporated by reference in its entirety.

### BACKGROUND

### 1. Field

The disclosure relates to interworking between a mobile communication system and a communication network external server. Specifically, the disclosure relates to a network exposure function-related technique for a server located outside a mobile communication network to obtain information necessary to provide a user service from a mobile communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

There is a need for a method for a server located outside a mobile communication network to obtain information necessary to provide a user service from a mobile communication system.

The above information is presented as background information only to assist with an understanding of the disclosure. No determination has been made, and no assertion is made, as to whether any of the above might be applicable as prior art with regard to the disclosure.

### SUMMARY

The disclosure provides a method for an external server located outside a mobile communication system to configure a temporary UE identifier for identifying a UE subscribing to the mobile communication system.

A method for an entity in a wireless communication system according to an embodiment of the disclosure may include receiving a temporary user equipment (UE) external identifier request message including at least one of an Internet protocol (IP) address of a UE and an application function (AF) identifier, obtaining a subscription permanent identifier (SUPI) of the UE, based on the IP address of the UE, obtaining an authentication and key management for applications (AKMA) key identifier (A-KID), based on at least one of the SUPI and the AF identifier, and generating a temporary UE external identifier, based on at least one of the A-KID and the AF identifier.

An entity in a wireless communication system according to an embodiment of the disclosure may include a transceiver; and a controller configured to control the transceiver to receive a temporary user equipment (UE) external identifier request message including at least one of an Internet protocol (IP) address of a UE and an application function (AF) identifier, perform control to obtain a subscription permanent identifier (SUPI) of the UE, based on the IP address of the UE, perform control to obtain an authentication and key management for applications (AKMA) key identifier (A-KID), based on at least one of the SUPI and the AF identifier, and perform control to generate a temporary UE external identifier, based on at least one of the A-KID and the AF identifier.

According to an embodiment of the disclosure, it is possible to obtain a temporary UE identifier of a UE subscribing to a mobile communication system as information necessary for an external server located outside the mobile communication system to provide a user service.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a scenario in which edge computing is configured without layer division;

FIG. 2 illustrates a structure in which an external server that generally uses authentication and key management for applications (AKMA) and a 3GPP network function interwork;

FIG. 3A is a sequence diagram illustrating a method for obtaining a temporary UE identifier using an A-KID according to an embodiment of the disclosure;

FIG. 3B is a sequence diagram illustrating a method for obtaining a temporary UE identifier when an NEF is provided with an IP address of a UE according to an embodiment of the disclosure;

FIG. 3C is a sequence diagram illustrating a method for obtaining a temporary UE identifier when an NEF is provided with an A-KID according to an embodiment of the disclosure;

FIG. 4 is a sequence diagram illustrating a method for an NEF to generate and manage a temporary UE identifier according to an embodiment of the disclosure;

FIG. 5 is a sequence diagram illustrating a method for configuring a temporary UE external identifier using a service provisioning procedure according to an embodiment of the disclosure;

FIG. 6 is a sequence diagram illustrating a method for configuring a temporary external identifier for a UE during an AKMA authentication procedure according to an embodiment of the disclosure;

FIG. 7 is a sequence diagram illustrating a method in which an EES manages a temporary UE external identifier according to an embodiment of the disclosure;

FIG. 8 is a sequence diagram illustrating a method in which an EES generates and manages a temporary UE external identifier for each of a plurality of EASs;

FIG. 9 is a block diagram illustrating the configuration of an entity according to an embodiment of the disclosure;

FIG. 10 is a block diagram illustrating the configuration of a server device according to an embodiment of the disclosure; and

FIG. 11 is a block diagram illustrating the configuration of a UE according to an embodiment of the disclosure.

### DETAILED DESCRIPTION

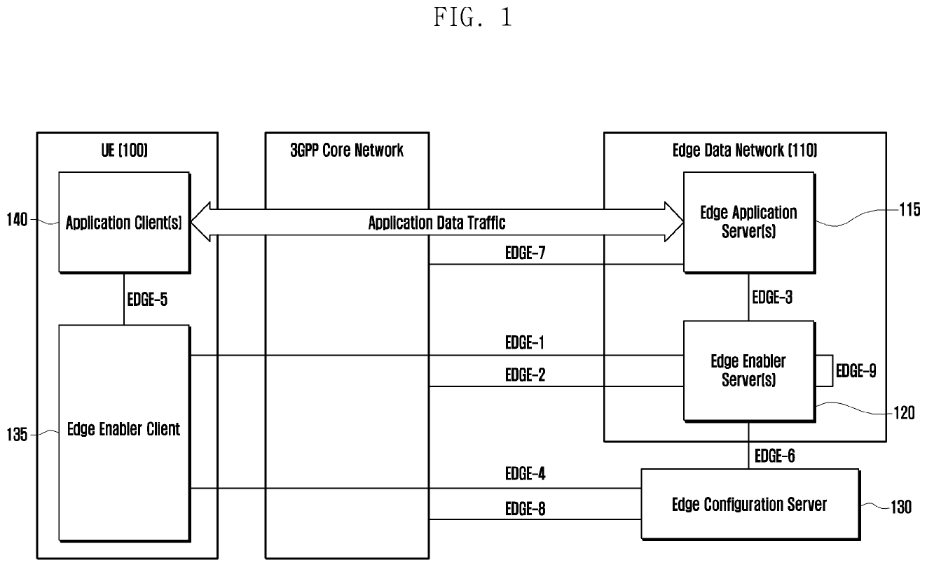

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

Hereinafter, the operation principle of the disclosure will be described in detail with reference to the accompanying drawings. The terms which will be described below are terms defined in consideration of the functions in the disclosure, and may be different according to users, intentions of the users, or customs. Therefore, the definitions of the terms should be made based on the contents throughout the specification.

In the disclosure, terms referring to network entities and entities of edge computing systems, terms referring to messages, terms referring to identification information, and the like are illustratively used for the convenience of description. Therefore, the disclosure is not limited by the terms as used below, and other terms referring to subjects having equivalent technical meanings may be used.

In the following description, the disclosure will be described using terms and names defined in the 5G system standards for the convenience of description. However, the disclosure is not limited by these terms and names, and may be applied in the same way to systems that conform other standards.

According to an embodiment, an external server disclosed below may include an edge computing server (edge enabler server: EES, edge configuration server: ECS, or edge application server: EAS).

For the external server installed outside a 3GPP mobile communication system of an operator to interwork with a communication system network function for providing a service to a user, a UE identifier is required. However, it is difficult to preconfigure a UE identifier identifiable within a 3GPP network for a subscriber UE in the external server in the mobile communication. A method for using a UE IP address is also limited, because a UE cannot be identified by an IP address when network address translation (NAT) is installed. In addition, there is a need for a method for allocating a different temporary identifier for each service used (or for each external server) so that it is impossible to track a user's personal information.

Accordingly, the disclosure provides a method of providing a UE identifier required for interworking with a mobile communication network to an external server. According to an embodiment, provided are a method of producing and transmitting a temporary UE identifier using an identifier of an authentication and key management for applications (AKMA) anchor key (AKMA key identifier: A-KID) provided to an AKMA anchor function (AAnF) performing a role of authentication and key management for applications (AKMA) and a method of producing and managing a different temporary UE identifier for each external application (or each external server).

For example, (1) a method in which an external server requests a network function (NF) of a communication system to generate a temporary UE identifier using an A-KID or application information, (2) a method of producing a different temporary UE identifier and managing validity for each external server for protection of a user's personal information, (3) a method of matching (or mapping) a generated temporary UE identifier with an external server and registering/updating the same in a unified data management (UDM), (4) a method of transmitting a generated temporary UE identifier to an external server using a network exposure function (NEF), and (5) a method of configuring a temporary UE identifier in a client in a UE using a session connection (e.g., an EDGE-1 or EDGE-4 interface) between the UE and an external server (e.g., an ECS or EES) may be included.

According to the foregoing embodiment, a temporary UE identifier is provided to an external server installed outside an operator's network of a mobile communication system, thereby enabling use of a 3GPP network exposure function for providing a service to a user.

Further, a method of providing a different temporary UE identifier for each service or external application server and configuring a temporary UE identifier in a client (e.g., an edge enabler client: EEC) in a UE is provided, thereby minimizing exposure of a fixed UE identifier (e.g., mobile station international subscriber directory number (MSISDN)) and tracking of a user's personal information.

FIG. 1 illustrates a scenario in which edge computing is configured without layer division. For example, FIG. 1 illustrates an edge computing system within a service area of a 3GPP mobile network operator.

Networks and edge computing entities shown in FIG. 1 are described as follows.

In the edge computing system, a UE 100 may transmit and receive application data traffic to and from an edge data network 110.

For example, the edge computing system may include an edge enabler server 120, an edge data network configuration server 130, and an edge enabler client (EEC) 135. The edge enabler server 120 builds an edge hosting environment (or edge computing platform), and may know information about an edge application server 115 running in the edge hosting environment.

The edge enabler server 120 may perform a function of negotiating with the UE 100 to connect an application client 140 of the UE 100 and the edge application server 115 in the edge hosting environment. The UE 100 supporting the edge computing system may have an edge enabler client 135 embedded therein. The negotiation may be performed through interworking between the edge enabler client 135 and the edge enabler server 120. A layer in which interworking between the edge enabler client 135 and an edge enabler, such as the negotiation, is performed may be referred to as an edge enabling layer. The UE 100 referred to in the disclosure may include not only a smartphone but also an IoT device and a vehicle.

The edge configuration server 130 knows deployment information about the edge enabler servers 120. The edge configuration server 130 may transmit configuration information for using an edge computing service to the UE 100. The configuration information may include edge data network connection information (e.g., a data network name, an S-NSSAI, and the like), an edge data network service area (e.g., a cell list, a list of a tracking area, and a PLMN ID), edge enabler server connection information (e.g., a URI), and the like. The edge data network service area may be an edge enabler server 120-available area configured by the edge enabler server 120. The UE may obtain information about an edge enabler server accessible at a specific location, based on the edge data network service area. When the edge data network configuration server is able to know information about an edge application server 115 running in an edge hosting environment of a specific edge enabler server 120, the UE 100 may also obtain the information through the edge enabler client 135.

The edge application server 115 refers to a third-party application server running in the edge computing system. For example, the edge application server 115 is a third application server running on the infrastructure provided by the edge hosting environment, and is able to provide a service at a location close to the UE 100, thus being able to provide an ultra-low latency service.

The application client 140, the edge enabler client 135 that links the application client 140 with an edge computing service, and a mobile terminal (MT, not shown) that accesses a mobile communication system may exist in the UE 100. An application of the UE 100 is an application provided by a third party and may refer to a client application program that runs in the UE for any application service. A plurality of applications may run in the UE 100. At least one of the applications may use a mobile edge computing service. The edge enabler client 135 in the UE 100 refers to a client that performs an operation in the UE 100 necessary to use an edge computing service. For example, the edge enabler client 135 may determine whether any application is able to use an edge computing service, and may perform an operation of connecting a network interface so that data of the application client 140 of the UE 100 may be transmitted to the edge application server 115 providing the edge computing service.

An operation of establishing a data connection for using an edge computing service may be performed in a 3GPP communication layer through the mobile terminal. The 3GPP communication layer may refer to a layer that performs a modem operation for using a mobile communication system. For example, the 3GPP communication layer may function to establish a wireless connection for data communication, to register the UE in the mobile communication system, to establish a connection for data transmission to the mobile communication system, and to transmit and receive data.

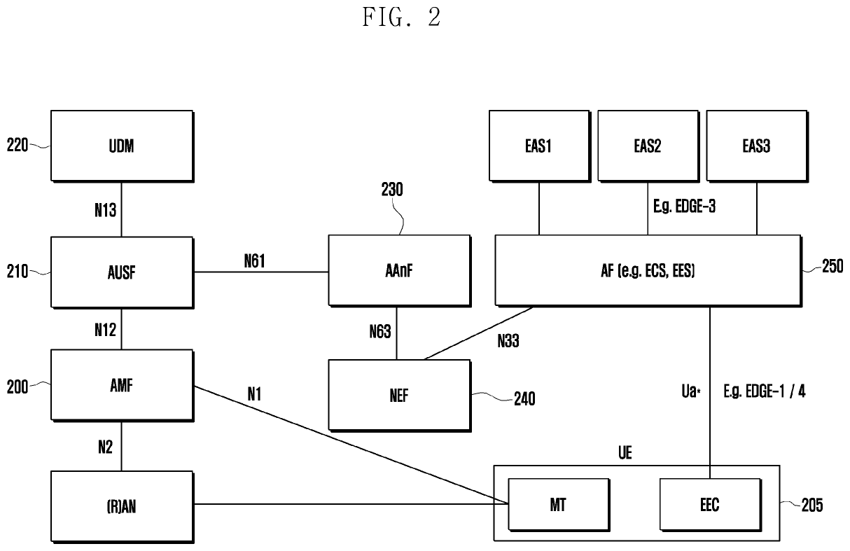

FIG. 2 illustrates a structure in which an external server that generally uses authentication and key management for applications (AKMA) and a 3GPP network function interwork.

When a UE 205 desires to access a 3GPP 5G network, the UE 205 may request a registration procedure from an access and mobility management function (AMF) 200. Here, an authentication procedure for the UE 205 may be performed. When a basic authentication procedure for the UE 205 is performed, an authentication server function (AUSF) 210 may transmit a UE authentication-related information request to a unified data management (UDM) 220. When whether to use AKMA is registered in subscriber information about the UE 205 (when information about whether AKMA is applied to a subscriber exists in the UDM), the UDM 220 may transmit an AKMA indication indicating whether AKMA is applied to the UE 205 to the AUSF 210. Upon receiving the AKMA indication from the UDM 220, the AUSF 210 may generate an AKMA anchor key (K_AKMA) and an AKMA key identifier (A-KID). The AUSF 210 may register the generated K_AKMA, the generated A-KID, and a subscription permanent identifier (SUPI) in an authentication and key management for applications (AKMA) anchor function (AAnF) 230.

The AAnF 230 may be installed/deployed in combination with the AUSF 210 or a network exposure function (NEF) 240. When the UE 205 transmits an application session establishment request to an application function (AF) 250, the A-KID may be included. The AF 250 may transmit an AKMA application key (K_AF) request message including the A-KID received from the UE 205 and an AF identifier (AF ID) of the AF 250 to the AAnF 230. The AF 250 may obtain an AKMA application key K_AF in response to the request message. When K_AF is successfully obtained, the AF 250 may accept the application session establishment request from the UE 205. When failing to obtain K_AF, the AF 250 may reject the application session establishment request. In a general AKMA-based authentication operation, the AF 250 may be an ECS or an EES of an edge computing system.

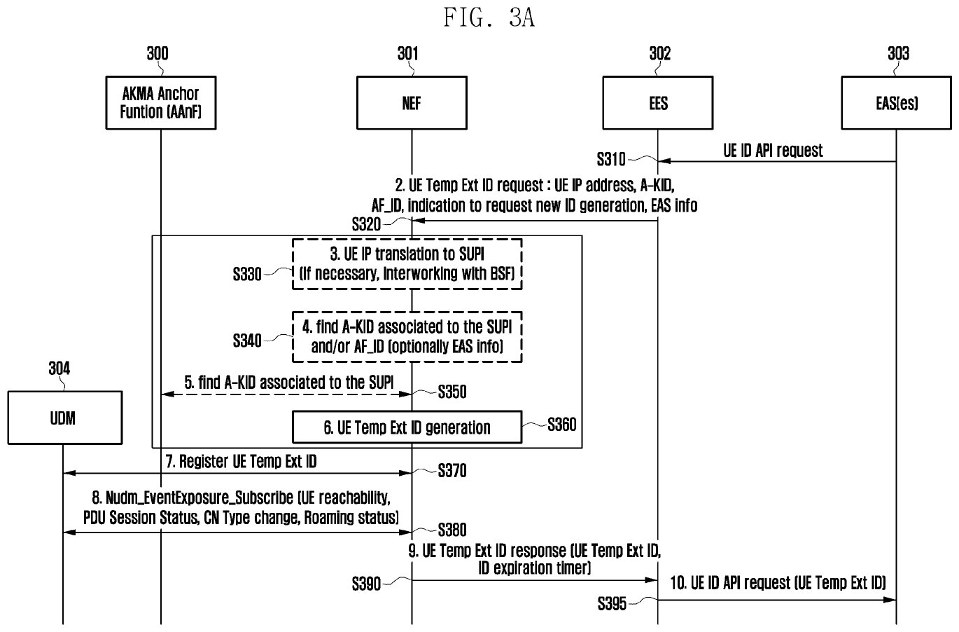

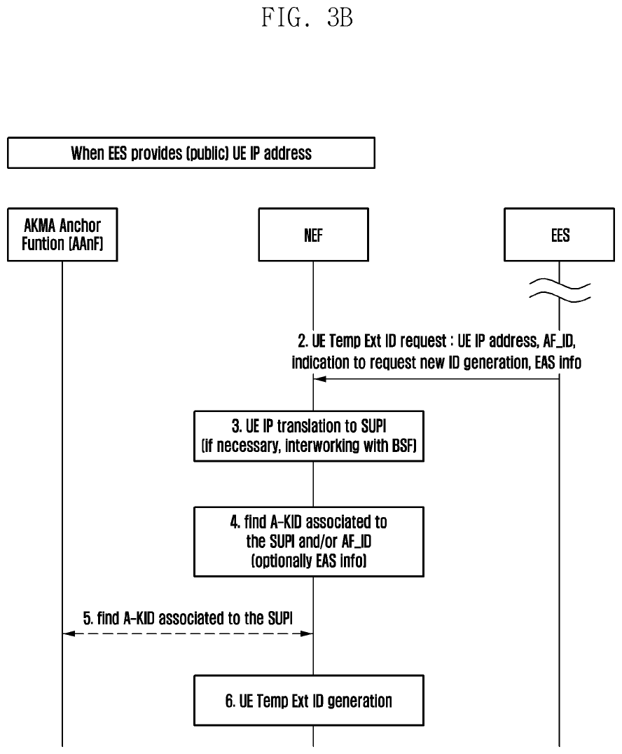

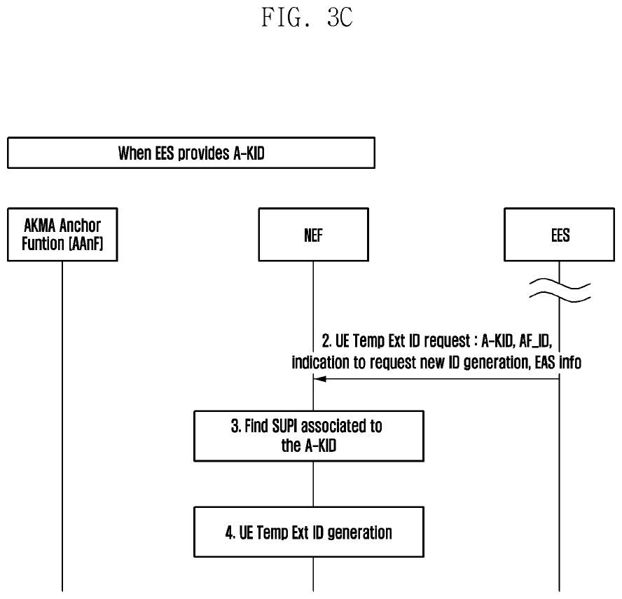

FIG. 3A is a sequence diagram illustrating a method for obtaining a temporary UE identifier according to an embodiment of the disclosure, FIG. 3B is a sequence diagram illustrating a method for obtaining a temporary UE identifier according to an embodiment of the disclosure, and FIG. 3C is a sequence diagram illustrating a method for obtaining a temporary UE identifier according to an embodiment of the disclosure.

Specifically, FIG. 3A is a sequence diagram illustrating a general method for obtaining a temporary UE identifier. FIG. 3B is a sequence diagram illustrating a method for obtaining a temporary UE identifier when an NEF is provided with an IP address of a UE according to an embodiment of the disclosure. FIG. 3C is a sequence diagram illustrating a method for obtaining a temporary UE identifier when an NEF is provided with an A-KID according to an embodiment of the disclosure.

In operation S310, at least one EAS 303 may transmit a UE ID application programming interface (API) request to an EES 302. The request message may include a UE IP address. The EES 302 and/or the EAS 303 may be arbitrary external servers.

In operation S320, the EES 302 may transmit a temporary UE external identifier (temporary external ID) request message to an NEF 301. The request message may include a UE IP address, an application function (AF) identifier (ID) of the EES, an additional temporary UE external identifier allocation indication, and EAS information (EAS ID, address information, EAS application ID, application ID for the EAS to provide a service, application port ID, and the like). When the EES 302 supports AKMA authentication, the request message may further include an A-KID, which is an AKMA key identifier.

The additional temporary UE external identifier allocation indication may refer to a request for generation and allocation of a new identifier other than a UE external identifier already generated/configured by the NEF 301.

When the A-KID is included in the temporary UE external identifier request message from the EES 302, the NEF 301 may identify the validity of the A-KID (e.g., may identify the validity of the A-KID by AAnF query and may obtain a SUPI of a UE identified by the A-KID from an AAnF) and may then perform operation S306 (generation of a temporary UE external identifier based on the A-KID and an AF ID without performing operations S330 to S350 to be described later.

Specifically, as shown in FIG. 3B, operations from operation S330 may be initiated when the NEF 301 receives the temporary UE external identifier request message including the UE IP address and not including the A-KID from the EES 302.

In operation S330, the NEF 301 may obtain the SUPI using the UE IP address. For example, when the UE IP address is included in the temporary UE external identifier request message and the A-KID is not included therein, the NEF 301 may find a SUPI value corresponding to the UE IP address. The NEF 301 may obtain the SUPI by providing the UE IP address for a binding support function or may determine the SUPI, based on a corresponding relationship between the UE IP address and the SUPI stored in the NEF 301.

In operation S340, the NEF 301 may find an A-KID with the SUPI. For example, the NEF 301 may find an A-KID corresponding to the obtained SUPI value. Alternatively, the NEF 301 may find an A-KID corresponding to the obtained SUPI value and the AF ID. During an AKMA authentication procedure, the A-KID and the SUPI value may be mapped and stored in the NEF 301. Therefore, the NEF 301 may obtain the A-KID corresponding to the SUPI value, based on information of the mapped A-KID and SUPI value.

In operation S350, the NEF 301 may obtain the A-KID from the AAnF 300 (A-KID retrieval from AAnF). For example, when mapping of the SUPI and the A-KID is not stored in the NEF 301, the NEF 301 may provide at least one of the SUPI value and the AF ID to the AAnF 300. The NEF 301 may receive an A-KID corresponding to at least one of the SUPI value and the AF ID.

In operation S360, the NEF 301 may generate a temporary UE external identifier. For example, the NEF 301 may generate a temporary UE external identifier available for a corresponding AF using the obtained A-KID value and the AF ID received from the EES 302. According to an embodiment, the NEF (301) may configure the temporary UE external identifier in a username@realm format by combining an AF fully qualified domain name (FQDN) part of the AF ID and a realm part of the A-KID. When both the AF ID and EAS information are received, the NEF 301 may configure a username part including the AF ID and the EAS information or may configure a username part using only the EAS information. When the “additional temporary UE external identifier allocation indication” is received from the EES 302, the NEF 301 needs to generate a new identifier other than a UE external identifier already generated/configured by the NEF 301. When receiving EAS information about a plurality of EASs 303 from the EES 302, the NEF 301 may generate a plurality of UE external identifiers for the respective EASs 303. For example, the NEF 301 may generate a plurality of temporary UE external identifiers respectively corresponding to the plurality of EASs 303. The NEF 301 may match (map) and store the generated temporary UE external identifier with the SUPI and the A-KID.

When the NEF 301 receives the temporary UE external identifier request message including the A-KID from the EES 302, the NEF 301 may obtain a SUPI using the A-KID included in the temporary UE external identifier request message received from the EES 302 as shown in FIG. 3C. The NEF 301 may generate a temporary UE external identifier using the A-KID, AFID or EAS information received from the EES 302 as above, and may match (map) and store the generated temporary UE external identifier with the obtained SUPI.

In operation S370, the NEF 301 may register the generated temporary UE external identifier in a UDM 304. For the registration, a message transmitted by the NEF 301 to the UDM 304 may include the generated temporary UE external identifier, the AF ID, and the EAS information (an identifier of an application port or an identifier of an application in the UE having an application session connected to the AF). The temporary UE external identifier may be registered in the UDM 304, being mapped with the SUPI, the AF ID, and the EAS information (the identifier of the application port or the identifier of the application in the UE having an application session connected to the AF). Alternatively, the NEF 301 may register the temporary UE external identifier corresponding to the SUPI, the AF ID, and the EAS information in a user data repository (UDR, not shown) other than the UDM 304.

In operation S380, the NEF 301 may subscribe to an event exposure notification service provided by the UDM 304 by transmitting a Nudm_EventExposure_Subscribe message to the UDM 304 in order to manage the validity period of the temporary UE external identifier. An event subjected to Nudm_EventExposure_Subscribe may include UE reachability, a PDU session status, a CN type change, a Roaming status, and the like. An A-KID validity period expiration condition may include the following.
When the validity period of the A-KID expires, the validity of the temporary UE external identifier also expires;
The validity of the temporary UE external identifier expires when the UE is deregistered;
The validity of the temporary UE external identifier expires when an application session between the UE and the AF expires. For example, when a PDU session in which an application session between the UE and the AF is established is released, the validity of the temporary UE external identifier may also expire (the same validity period as a PDU session lifetime): and/or
When a core network (CN) type of the UE changes, the validity of the temporary UE external identifier may also expire. For example, when the CN Type of the UE changes from a 5GC to an evolved packet core (EPC), the validity of the A-KID-based temporary UE external identifier may also expire because AKMA authentication is unavailable in the EPC.

In another embodiment, the NEF 301 may transmit a request for subscription to the event exposure notification service to an AMF or an SMF. In this case, the NEF 301 may receive a notification of occurrence of an event, such as deregistration of the UE, UE reachability, a CN type change, a roaming status, and a PDU session status, directly from the AMF or SMF.

When the NEF 301 receives the notification of the occurrence of the event, the NEF 301 may determine that the validity of the temporary UE external identifier generated in operation S360 has expired.

In operation S390, the NEF 301 may transmit the temporary UE external identifier to the AF (EES). A plurality of temporary UE external identifiers may be transmitted, and each temporary UE external identifier may be different for each application server (e.g., EAS) connected to the AF (e.g., the EES).

In operation S395, the EES 302 may transmit the temporary UE external identifier received from the NEF 301 to the EAS 303. Alternatively, the EES 302 may transmit an EDGE-3-dedicated UE identifier obtained by modifying the temporary UE external identifier received from the NEF 301 for each EAS 303. Specifically, the NEF 301 may provide one temporary UE external identifier to the EES 302, and the EES 302 may generate and manage a plurality of EDGE-3 interface (interface between the EES 302 and the EAS 303)-dedicated UE identifiers corresponding to the temporary UE external identifier received from the NEF 301. A different EDGE-3-dedicated UE identifier may be allocated to each EAS 303 registered in the EES 302.

According to the foregoing disclosure, an external server located outside a mobile communication network may obtain a temporary UE identifier of a UE subscribing to the mobile communication system, thereby providing a service for the UE. For example, the external server that is unable to identify information, such as an IP address, may easily provide a service for the UE, based on the temporary UE identifier. As described with reference to FIG. 3A to FIG. 3C, the external server may obtain the temporary UE external identifier of the UE by requesting from the NEF.

Here, since the temporary UE external identifier is used, the UE may avoid exposure of personal information. In addition, a different temporary UE external identifier is generated for each application server (e.g., EAS) and thus a different temporary UE external identifier is used depending on an external server, making it possible to prevent the personal information about the UE from being exposed to the external server.

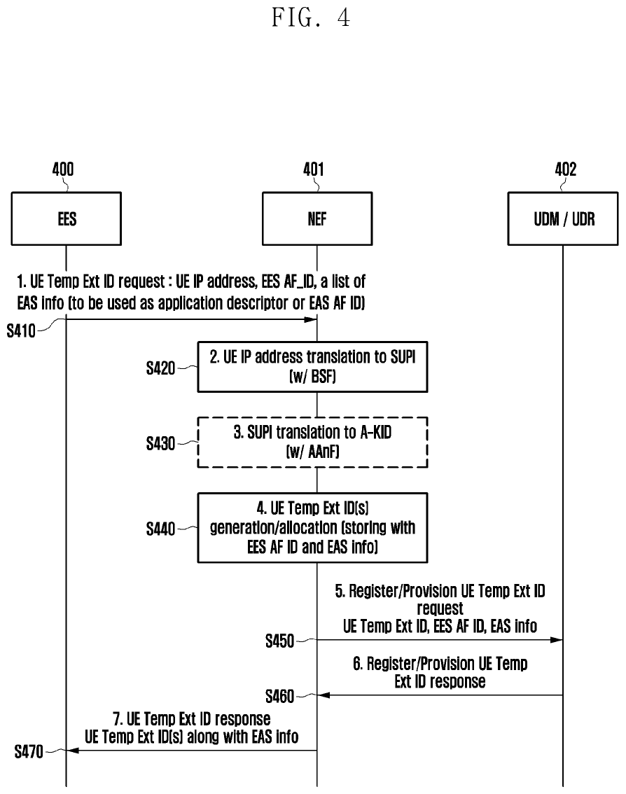

FIG. 4 is a sequence diagram illustrating a method for an NEF to generate and manage a temporary UE identifier according to an embodiment of the disclosure.

In operation S410, an EES 400 transmits a temporary UE external identifier request message to an NEF 401. The request message may include a UE IP address, an AF ID of the EES, and information about EASs registered in the EES. The information about EASs may include an application descriptor of a service provided by an EAS, an EAS AF ID, an OS app ID (identifier of an application receiving a service from an EAS in the UE), an application port ID (port identifier of an application receiving a service from an EAS in the UE), and the like.

In operation S420, the NEF 401 may find a SUPI value corresponding to the UE IP address included in the temporary UE external identifier request message received from the EES 400. To obtain the SUPI value, the NEF 401 may provide the UE IP address to a binding support function (BSF) and may obtain the SUPI value from the BSF, or may determine a SUPI, based on IP address-SUPI mapping information stored in the NEF 401.

In operation S430, the NEF 401 may obtain an A-KID value corresponding to the obtained SUPI as described above. To obtain the A-KID value, the NEF 401 may provide the SUPI value to an AAnF and may obtain the A-KID value from the AAnF. Alternatively, the NEF 401 may find the A-KID, based on A-KID-SUPI mapping information stored in the NEF 401. The A-KID corresponding to the SUPI and the UE IP address obtained from the EES may be mapped and stored in the NEF 401.

In operation S440, the NEF 401 may generate a temporary UE external identifier may map and store the temporary UE external identifier with the UE IP address, the SUPI, and the A-KID. When the message transmitted from the EES 400 to the NEF 401 includes information about a plurality of EASs, the NEF 401 may generate a temporary UE external identifier for each of the plurality of EASs. The NEF 401 may store the generated temporary UE external identifier as information for mapping with the EES AF ID and the information about the EASs (application descriptor, EAS AF ID, OS app ID, and application port ID).

In operation S450, the NEF 401 may register/configure the temporary UE external identifier generated by the foregoing method as the information for mapping with the EES AF ID and the information about the EASs in a UDM or UDR 402.

In operation S460, the UDM or UDR 402 may transmit a response to a registration/configuration request from the NEF 401 to the NEF 401.

In operation S470, when the NEF 401 receives a successful registration/configuration response from the UDM or UDR 402, the NEF 401 may transmit the temporary UE external identifier to the EES 400. A plurality of temporary UE external identifier may be generated, and may be mapped with pieces of EAS information and provided to the EES 400.

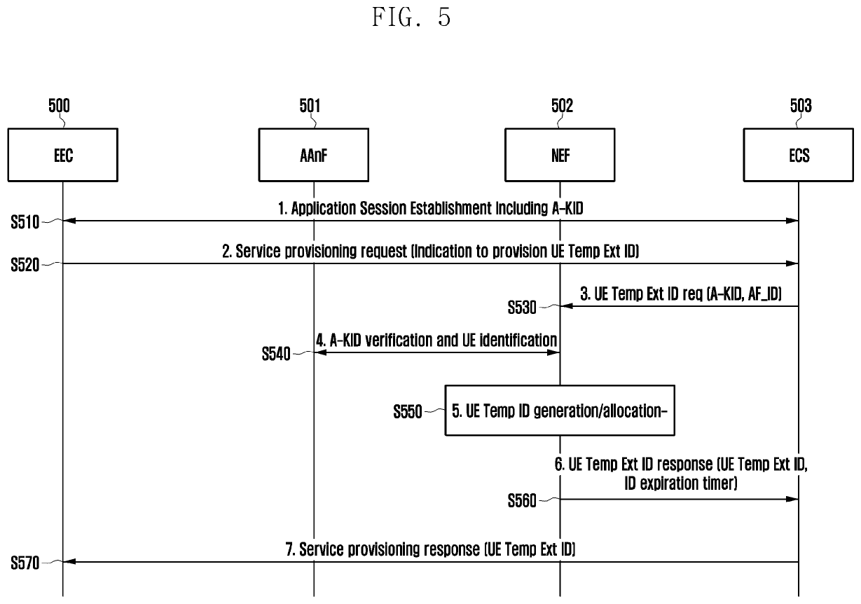

FIG. 5 is a sequence diagram illustrating a method for configuring a temporary UE external identifier using a service provisioning procedure according to an embodiment of the disclosure.

In operation S510, an EEC 500 in a UE may perform an application session establishment procedure for performing a service provisioning procedure with an ECS 503. During the application session establishment procedure between the EEC 500 and the ECS 503, the EEC 500 may provide an A-KID to the ECS 503. The ECS 503 may perform an AKMA authentication procedure using the received A-KID, and the application session establishment procedure between the EEC 500 and the ECS 503 may be completed.

In operation S520, the EEC 500 may transmit a service provisioning request message to the ECS 503 to receive edge configuration information from the ECS 503. When the EEC 500 does not have information about a temporary UE external identifier, the EEC 500 may transmit the service provisioning request message including a temporary UE external identifier configuration request indication, or may transmit the request message to the ECS 503 without including information about a UE identifier.

In operation S530, when the temporary UE external identifier configuration request indication is included or the information about the UE identifier is not included in the service provisioning request message received from the EEC 500, the ECS 503 may transmit a temporary UE external identifier request message to an NEF 502. The temporary UE external identifier request message transmitted from the ECS 503 to the NEF 502 may include at least one of an A-KID and an AF ID of the ECS 503. If necessary, the ECS 503 may further include an AF ID of an EES expected to transmit an EEC registration or EAS discovery request message in the request message and may transmit the request message to the NEF 502.

In operation S540, the NEF 502 may perform a verification procedure for the A-KID received from the ECS 503. In addition, the NEF 502 may obtain a SUPI value by identifying a UE indicated by the A-KID. To obtain the SUPI value, the NEF 502 may transmit the A-KID received from the ECS 503 to an AAnF 501, and may obtain a SUPI for the UE corresponding to the A-KID.

In operation S550, the NEF 502 may generate/allocate a temporary UE external identifier indicated by the A-KID received from the ECS 503. For example, the NEF 502 may generate/allocate a temporary UE external identifier corresponding to the AF ID received from the ECS 503 and the autonomously obtained SUPI. The NEF 502 may register the generated temporary UE external identifier in a UDM. A message transmitted by the NEF 502 to the UDM for this registration may include the generated temporary UE external identifier, the AF ID, the SUPI, and the like. The temporary UE external identifier may be mapped to the SUPI and the AF ID and registered in the UDM. Alternatively, the temporary UE external identifier may be registered corresponding to the SUPI of the UE and the AF ID in a UDR other than the UDM.

In operation S560, the NEF 502 may transmit the generated/allocated temporary UE external identifier to the ECS 503. For example, the NEF 502 may transmit a response message including the temporary UE external identifier to the temporary UE external identifier request message from the ECS 503.

In operation S570, the ECS 503 may transmit a service provisioning response message including the temporary UE external identifier received from the NEF 502 along with edge configuration information to the EEC 500.

When the EEC 500 receives the temporary UE external identifier through the service provisioning response message, the EEC 500 may use the received temporary UE external identifier when subsequently communicating with an edge computing server (ECS or EES). For example, when a UE identifier needs to be included when transmitting a service provisioning request message to the ECS 503 or transmitting an EEC registration request, an EAS discovery request, or an application context relocation initiation request message to the EES, the EEC 500 may use the temporary UE external identifier received from the ECS 503.

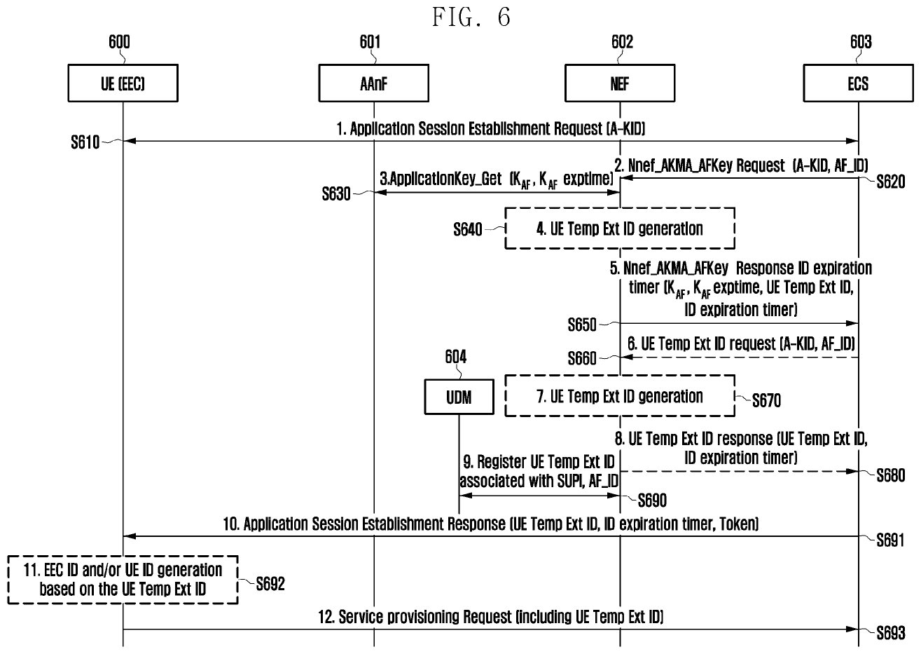

FIG. 6 is a sequence diagram illustrating a method for configuring a temporary external identifier for a UE during an AKMA authentication procedure according to an embodiment of the disclosure.

In operation S610, a UE 600 (e.g., an EEC of the UE) may perform an application session establishment procedure including an AKMA authentication procedure. The UE 600 may transmit an application session establishment procedure request message to an ECS 603.

In operation S620, the ECS 603 may transmit an AKMA key request to an NEF 602. The ECS 603 may transmit the AKMA key request to an AAnF 601 through an NEF 602. An AKMA key request message may include an A-KID and an AF_ID.

In operation S630, the NEF 602 may obtain a K_AF and a K_AF expiration time from the AAnF 601.

After successfully receiving the K_AF from the AAnF 601, the NEF 602 may generate a temporary UE external identifier, based on the A-KID and AF_ID received from the ECS 603 in operation S640.

When the temporary UE external identifier is generated in S640, the NEF 602 may transmit an AKMA key request response message including the K_AF and K_AF expiration time obtained from the AAnF 601 and the temporary UE external identifier to the ECS 603 in operation S650.

When the temporary UE external identifier is not included in the AKMA key request response message received from the NEF 602, the ECS 603 may transmit a temporary UE external identifier request message to the NEF 602 according to an edge computing service provider policy in operation S660. The temporary UE external identifier request message may include the A-KID and the AF ID of the ECS.

After receiving the temporary UE external identifier request message from the ECS 603, the NEF 602 may generate a temporary UE external identifier as in the previous operation S604 in operation S670. For example, the NEF 602 may generate a temporary UE external identifier, based on the A-KID and AF_ID included in the request message transmitted by the ECS 603.

In operation S680, the NEF 602 may transmit the generated temporary UE external identifier to the ECS 603.

In operation S690, the NEF 602 may register the temporary UE external identifier in a UDM 604. For example, after transmitting the generated temporary UE external identifier to the ECS 603, the NEF 602 may register the temporary UE external identifier in the UDM 604. When registering the temporary UE external identifier, the temporary UE external identifier may be registered corresponding to a SUPI of the UE and the AF ID in the UDM 604. Alternatively, the temporary UE external identifier may be registered corresponding to the SUPI of the UE and the AF ID in a UDR other than the UDM 604.

When the ECS 603 successfully establishes an application session including AKMA authentication with the UE (EEC) 600, the ECS 603 may include the temporary UE external identifier obtained in the above process in a response message to the application session establishment request and may transmit the response message to the UE 600 in operation S691.

In operation S692, the UE (EEC) 600 may store the temporary UE external identifier included in the application session establishment request response message received from the ECS 603. In addition, the UE (EEC) 600 may use the received temporary UE external identifier for a message (e.g., a service provisioning request, an EEC registration request, an EAS discovery request, or an application context relocation initiation request) subsequently transmitted to the ECS 603 or the EES. According to an embodiment, the UE (EEC) 600 may generate an EEC ID by modifying the temporary UE external identifier received from the ECS 603.

In operation S693, the UE (EEC) 600 may include the temporary UE external identifier or EEC ID obtained or regenerated in the foregoing operation in a message (e.g., a service provisioning request, an EEC registration request, an EAS discovery request, or an application context relocation initiation request) transmitted to the ECS 603 or EES. For example, the UE (EEC) 600 may transmit a service provisioning request message including the temporary UE external identifier to the ECS 603.

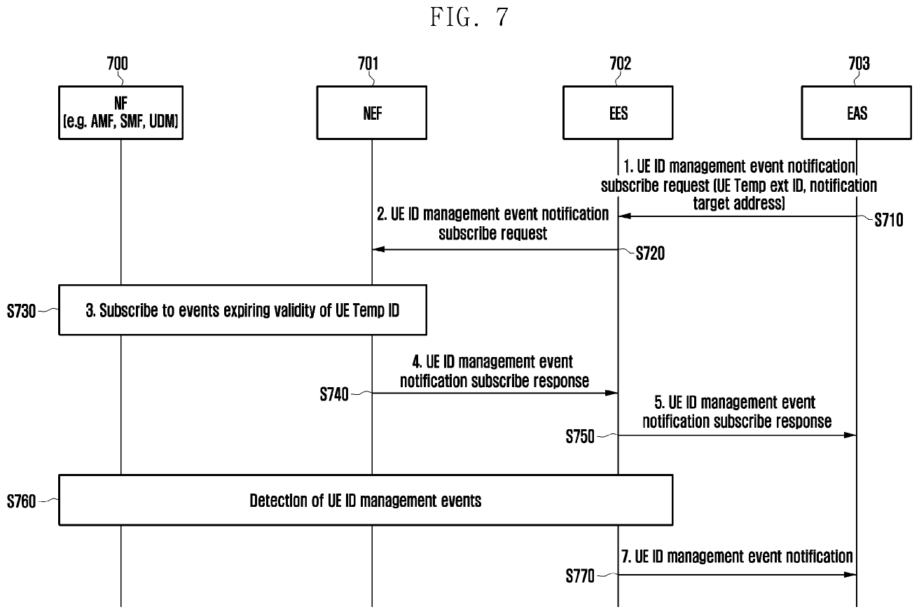

FIG. 7 is a sequence diagram illustrating a method in which an EES manages a temporary UE external identifier according to an embodiment of the disclosure.

After obtaining a temporary UE external identifier from an EES 702, an EAS 703 may request a subscription to an event notification service related to management (change or validity expiration) of the received identifier in operation S710. The subscription request message may include a UE identifier, a notification target address, and the like.

In operation S720, the EES 702 may request a subscription to a temporary UE external identifier management event notification service from an NEF 701. Alternatively, the EES 702 may request a notification service relating to occurrence of the following event from the NEF 701:
Deregistration of a UE;
Expiration of the validity of the temporary UE external identifier when an application session between the UE and an AF expires. For example, when a PDU session in which an application session between the UE and the AF is established is released, the validity of the temporary UE external identifier may also expire (the same validity period as a PDU session lifetime); and/or
When a CN type of the UE changes, the validity of the temporary UE external identifier may also expire. For example, when the CN Type of the UE changes from a 5GC to an EPC, the validity of the A-KID-based temporary UE external identifier may also expire because AKMA authentication is unavailable in the EPC.

In operation S730, the NEF 701 may subscribe to an event occurrence notification service related to a different 3GPP NF (e.g., an AMF, an SMF, a UDM, or an AAnF) in order to monitor whether an event related to the management of the temporary UE external identifier received from the EES 702 occurs. According to an embodiment, the NEF 701 may make a request for a subscription to an A-KID validity expiration event notification service from an AAnF. An A-KID validity expiration event notification subscription request message transmitted from the NEF 701 to the AAnF may include an A-KID, an AF ID, a SUPI, an indication for an updated A-KID, and the like.

When the request for the subscription is accepted by the AAnF, the AAnF may transmit a notification of occurrence of a corresponding event to the NEF 701 when the validity of the A-KID expires. Alternatively, when the indication for the updated A-KID is included in the notification subscription request message transmitted from the NEF 701 to the AAnF, the AAnF may not immediately transmit a notification message indicating that the validity of the A-KID expires to the NEF 701 when the validity of the A-KID expires. When a new (valid) A-KID for the UE is generated, the AAnF may transmit a notification message including the newly generated valid A-KID to the NEF 701.

In operation S740, the NEF 701 prepares to be able to detect whether the event related to the management of the temporary UE external identifier has occurred, and then transmits a response message to the EES 702. The response message may include a subscription correlation ID and the expiration time of a notification service.

In operation S750, the EES 702 may transmit the response message received from the NEF 701 to the EAS 703.

In operation S760, the occurrence of an event, such as the deregistration of the UE, the expiration of the application session between the UE and the AF, a change in the CN type of the UE (5GC to EPC), the expiration of the validity of the A-KID, EEC deregistration from the EES, may be detected. Here, in operation S770, the EES 702 may transmit a notification message (UE ID management event notification message) of the occurrence of the event to the EAS 703. When the EES 702 obtains the newly generated A-KID (from the AAnF) due to the expiration of the validity of the A-KID, the EES 702 may generate a new temporary UE external identifier and may include the new temporary UE external identifier in the UE ID management event notification message to be transmitted to the EAS 703.

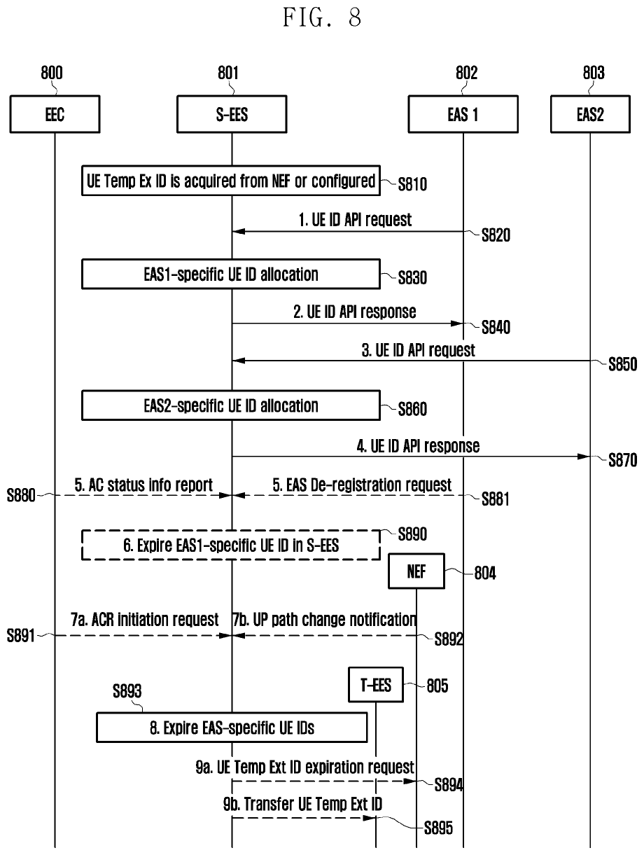

FIG. 8 is a sequence diagram illustrating a method in which an EES generates and manages a temporary UE external identifier for each of a plurality of EASs. The method of FIG. 8 provides a method for reducing involvement/loads of a 3GPP CN (signaling load between an NEF and an EES and signaling load for UE identifier UDM/UDR registration within the 3GPP CN) in generation and management of an EAS-dedicated temporary UE external identifier. For example, when a UE identifier is requested from a plurality of EASs, an EES may perform generation and management of a UE identifier for autonomously preventing personal information tracking without incurring signaling between the EES and the 3GPP CN in each request.

In an embodiment illustrated in FIG. 8, when a temporary UE external identifier is stored in an EES 801 (S810), the operation of the EES is started in a case where a UE identifier request is received from an EAS registered in the EES 801. An EAS1 802 and an EAS2 803 of FIG. 8 may be a plurality of servers providing a service for one UE. The EES 801 may be a source EES.

In operation S820, the EAS1 802 transmits a UE identifier request message to the EES 801. The UE identifier request message includes UE-related information, such as an IP address of the UE.

In operation S830, the EES 801 may identify a temporary UE external identifier matching UE information received from the EAS1, and may generate/allocate an EAS1-dedicated temporary UE identifier (a UE identifier to be used only in an EDGE-3 interface between the EAS1 and the EES). In operation S840, the EES 801 may transmit the generated/allocated temporary UE identifier to the EAS1 802.

In operation S850, the EAS2 803 may transmit a UE identifier request message to the EES 801. The UE identifier request message may include the UE-related information, such as the IP address of the UE.

In operation S860, the EES 801 may identify a temporary UE external identifier (UE identifier obtained from an NEF) matching UE information received from the EAS2 803, and may generate/allocate an EAS2-dedicated temporary UE identifier, different from the already allocated EDGE-3-dedicated temporary UE identifier (EAS1-dedicated temporary UE identifier), to the UE.

In operation S870, the EES 801 may transmit the EAS2-dedicated temporary UE identifier to the EAS2 803. The EES 801 may store a corresponding relationship between the temporary UE external identifier obtained from the NEF and the EAS1/EAS2-dedicated UE identifiers. When a capability exposure request is received from the EAS1 802 or the EAS2 803 and the EES 801 requires an operation of requesting information about the UE or a service from the NEF or 3GPP NF due to the request, the EES 801 may generate an AF request message to be transmitted to the NEF or 3GPP NF, including/using the temporary UE external identifier obtained from the NEF.

In operation S880 or operation S881, when the EES 801 receives status information (e.g., AC operation termination) about an application client (AC) connected to the EAS1 802 from an EEC 800 or receives an EAS deregistration request message from the EAS1 802, the EES 801 may identify that a service of the EAS1 802 is not provided to the UE. Operation S880 or S881 may be applied to all cases in which the EES 801 can identify that the service of the EAS1 802 is no longer provided to the UE in addition to the foregoing situation.

In operation S890, when the EES 801 recognizes that the EAS1 802 suspends the service for the specific UE in the foregoing operation, the EES 801 may expire the validity of the UE identifier dedicated to the EAS1 802 (the UE identifier dedicated to the EDGE-3 interface between the EAS1 and the EES). The expired EDGE-3-dedicated UE identifier may be withdrawn and may be reused for another UE or another EAS.

The EES 801 may receive an application context relocation initiation request from the EEC 800 in operation S891 or may receive a UP path change notification from a 3GPP network (e.g., the NEF 804) in operation S892. Here, the EES 801 may perform application context relocation for a target EES 805.

In operation S893, when the application context relocation is successfully performed in the foregoing operation, the EES 801 may expire the validity of the EAS-dedicated UE identifier (EAS1/EAS2 dedicated UE identifier mentioned above) allocated to the UE in which the EEC 800 is installed within the EES 801.

In operation S894, the EES 801 may transmit a validity expiration request for the allocated temporary UE external identifier to the NEF 804. In operation S895, the source EES 801 may transmit the temporary UE external identifier obtained from the NEF 804 to the target EES 805 according to an edge computing service policy. A validity expiration request message for the temporary UE external identifier to the NEF 804 may include the AF ID of the source EES 801 and the temporary UE external identifier of which the expiration is requested.

In FIG. 8, the EAS1 802 and the EAS2 803 may each make a request for a subscription to a notification service (notification transmitted from the EES to the EAS) for a validity expiration event of the allocated EDGE-3-dedicated UE identifier.

Although an edge computing server has been described as a specific embodiment in the description of the disclosure, all application servers capable of interworking with a 3GPP network system are included in the scope of application of the disclosure.

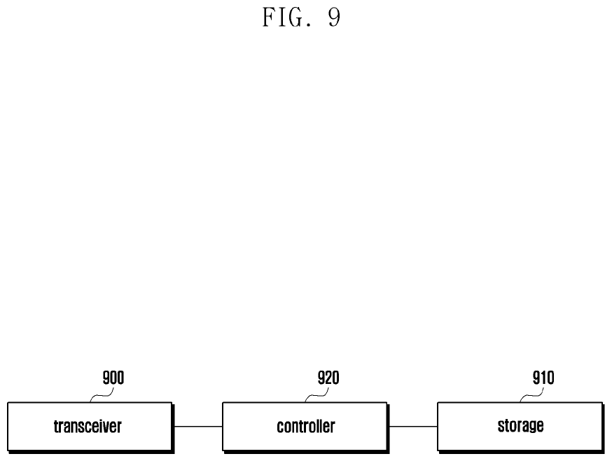

FIG. 9 is a block diagram illustrating the configuration of an entity according to an embodiment of the disclosure. The entity may be an entity that performs a network exposure function (NEF).

The entity may include a transceiver 900, a storage 910, and a controller 920. The transceiver 900 may transmit and receive a signal to and from another network entity. The transceiver 900 may receive a request message, for example, from an EES. The transceiver 900 may communicate with an application server (e.g., an EAS) through the EES.

The storage 910 may store at least one of information transmitted and received through the transceiver 900 and information generated through the controller 920.

In the disclosure, the controller 920 may be defined as a circuit, an application-specific integrated circuit, or at least one processor.

The controller 920 may control the overall operation of the entity according to an embodiment provided in the disclosure. According to an embodiment, the controller 920 may control the transceiver 900 to receive a temporary user equipment (UE) external identifier request message including at least one of an Internet protocol (IP) address of a UE and an application function (AF) identifier.

Further, the controller 920 may perform control to obtain a subscription permanent identifier (SUPI) of the UE, based on the IP address of the UE, and obtain an authentication and key management for applications (AKMA) key identifier (A-KID), based on at least one of the SUPI and the AF identifier.

In addition, the controller 920 may perform control to generate a temporary UE external identifier, based on at least one of the A-KID and the AF identifier.

The controller 920 may perform control to generate the temporary UE external identifier, based on the A-KID and the AF identifier included in the temporary UE external identifier request message, when the temporary UE external identifier request message includes the A-KID.

The controller 920 may perform control to generate a new temporary UE external identifier that is not previously generated by the entity, when the temporary UE external identifier request message includes an additional temporary UE external identifier allocation indication.

The controller 920 may perform control to generate a plurality of temporary UE external identifiers, based on a plurality of pieces of server information, respectively, when the temporary UE external identifier request message includes the plurality of pieces of server information.

The controller 920 may control the transceiver 900 to transmit at least one of the generated temporary UE external identifier, the AF identifier, and server information to an entity performing a unified data management (UDM) function.

The controller 920 may control the transceiver 900 to transmit the generated temporary UE external identifier to at least one server. When the generated temporary UE external identifier is generated for each of a plurality of servers, each of the generated temporary UE external identifiers may be transmitted to each of the plurality of servers.

The controller 920 may control the transceiver 900 to transmit the SUPI to an authentication and key management for applications (AKMA) anchor function (AAnF), and receive the A-KID corresponding to the SUPI from the AAnF.

The controller 920 may perform control to map and store the A-KID corresponding to the SUPI and the IP address included in the temporary UE external identifier request message in a storage 910.

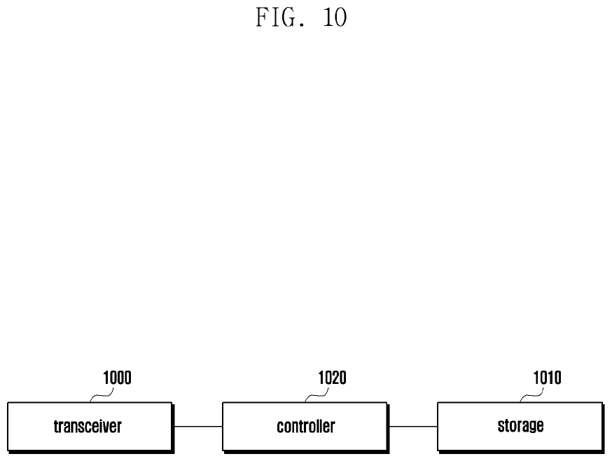

FIG. 10 is a block diagram illustrating the configuration of a server device according to an embodiment of the disclosure. The server device may include a transceiver 1000, a storage 1010, and a controller 1020. The transceiver 1000 may transmit and receive a signal to and from another network entity. The transceiver 1000 may transmit and receive information to and from an entity, for example, an NEF.

The storage 1010 may store at least one of information transmitted and received through the transceiver 1000 and information generated through the controller 1020. For example, the storage 1010 may store a temporary UE external identifier received through the transceiver 1000.

The controller 1020 may be defined as a circuit, an application-specific integrated circuit, or at least one processor. The controller 1020 may control the overall operation of a UE according to an embodiment provided in the disclosure. For example, the controller 1020 may provide a service to the UE using the received temporary UE external identifier.

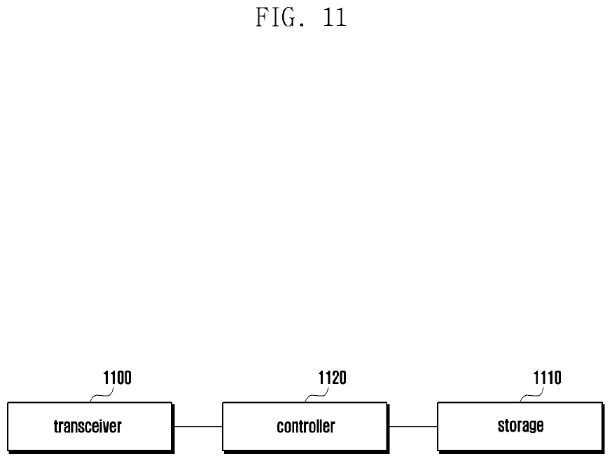

FIG. 11 is a block diagram illustrating the configuration of a UE according to an embodiment of the disclosure. The UE may include a transceiver 1100, a storage 1110, and a controller 1120. The transceiver 1100 may transmit and receive a signal to and from another network entity. The transceiver 1100 may transmit and receive information to, for example, an external server such as an application server.

The storage 1110 may store at least one of information transmitted and received through the transceiver 1100 and information generated through the controller 1120. For example, the storage 1110 may store a temporary UE external identifier received through the transceiver 1100 so that the received temporary UE external identifier may be used in subsequent communication with an edge computing server.

The controller 1120 may be defined as a circuit, an application-specific integrated circuit, or at least one processor. The controller 1020 may control the overall operation of the UE according to an embodiment provided in the disclosure. For example, the controller 1120 may perform control to perform an application session establishment procedure with an application server. Further, as described above, the controller 1120 may control the temporary UE external identifier received through the transceiver 1100 to be stored in the storage 1110. The controller 1120 may control the received temporary UE external identifier to be used in communication between the UE and an edge computing server. Although specific embodiments have been described in the detailed description of the disclosure, various modifications are possible without departing from the scope of the disclosure. Therefore, the scope of the disclosure should not be limited to the described embodiments and should be defined not only by the claims to be described below but also by equivalents to the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a network entity in a wireless communication system, the method comprising:
receiving, from a server, a user equipment (UE) identifier (ID) request message including at least one of an internet protocol (IP) address of a UE or an application function (AF) ID;
generating a UE ID based on at least one of the IP address of the UE or the AF ID; and
transmitting, to the server, a response message including the generated UE ID.

2. The method of claim 1, further comprising:
obtaining a subscription permanent identifier (SUPI) of the UE based on the IP address of the UE; and
generating the UE ID based on the obtained SUPI.

3. The method of claim 2, further comprising:
transmitting, to a binding support function (BSF) entity, the IP address of the UE; and
receiving, from the BSF entity, the SUPI corresponding to the IP address of the UE.

4. The method of claim 1, wherein the UE ID request message further includes an application port ID.

5. The method of claim 1, further comprising:
receiving, from the server, an authentication and key management for applications (AKMA) key request message including an AKMA key identifier (A-KID) and the AF ID for an AKMA authentication procedure; and
transmitting, to the server, the UE ID based on the A-KID and the AF ID.

6. The method of claim 1, further comprising:
transmitting, to a unified data management (UDM) entity, at least one of the generated UE ID, the AF ID, or an application port ID.

7. The method of claim 1, wherein the UE ID is a temporary UE external ID.

8. The method of claim 1, further comprising:
obtaining a SUPI of the UE based on the IP address of the UE;
transmitting the SUPI to an AKMA anchor function (AAnF) entity;
receiving, from the AAnF entity, an A-KID corresponding to the SUPI; and
generating the UE ID based on at least one of the A-KID or the AF ID.

9. The method of claim 8, further comprising:
mapping and storing the A-KID corresponding to the SUPI and the IP address included in the UE ID request message when the UE ID request message includes the IP address of the UE.

10. The method of claim 1, wherein the network entity is a network exposure function (NEF) entity.

11. A network entity in a wireless communication system, the network entity comprising:
a transceiver; and
at least one processor configured to:
receive, from a server via the transceiver, a user equipment (UE) identifier (ID) request message including at least one of an internet protocol (IP) address of a UE or an application function (AF) ID,
generate a UE ID based on at least one of the IP address of the UE or the AF identifier, and
transmit, to the server via the transceiver, a response message including the generated UE ID.

12. The network entity of claim 11, wherein the at least one processor is further configured to:
obtain a subscription permanent identifier (SUPI) of the UE based on the IP address of the UE, and
generate the UE ID based on the obtained SUPI.

13. The network entity of claim 12, wherein the at least one processor is further configured to:
transmitting, to a binding support function (BSF) entity via the transceiver, the IP address of the UE; and
receiving, from the BSF entity via the transceiver, the SUPI corresponding to the IP address of the UE.

14. The network entity of claim 11, wherein the UE ID request message further includes an application port ID.

15. The network entity of claim 11, wherein the at least one processor is further configured to:
receive, from the server via the transceiver, an authentication and key management for applications (AKMA) key request message including an AKMA key identifier (A-KID) and the AF ID, for an AKMA authentication procedure; and
transmit, to the server via the transceiver, the UE ID based on the A-KID and the AF ID.

16. The network entity of claim 11, wherein the at least one processor is further configured to:
transmit, to a unified data management (UDM) entity via the transceiver, at least one of the generated UE ID, the AF ID, or an application port ID.

17. The network entity of claim 11, wherein the UE ID is a temporary UE external ID.

18. The network entity of claim 11, wherein the at least one processor is further configured to:
obtain a SUPI of the UE based on the IP address of the UE;
transmit, via the transceiver, the SUPI to an AKMA anchor function (AAnF) entity;
receive, from the AAnF entity via the transceiver, an A-KID corresponding to the SUPI; and
generate the UE ID based on at least one of the A-KID or the AF ID.

19. The network entity of claim 18, wherein the at least one processor is further configured to:
map and store the A-KID corresponding to the SUPI and the IP address included in the UE ID request message when the UE ID request message includes the IP address of the UE.

20. The network entity of claim 11, wherein the network entity is a network exposure function (NEF) entity.
